(19) United States
(12) Patent Application Publication
(10) Pub. No.: US 2025/0233228 A1
(43) Pub. Date: Jul. 17, 2025

(54) CASE WITH THERMAL MANAGEMENT

(71) Applicant: Apple Inc., Cupertino, CA (US)

(72) Inventors: Jonathan M. ANDERSON, San Francisco, CA (US); Jacqueline M. AHRENS, San Francisco, CA (US); David J. DUNSMOOR, San Jose, CA (US)

(21) Appl. No.: 18/415,566

(22) Filed: Jan. 17, 2024

(51) Int. Cl. H01M 10/6551; H01M 10/623; H01M 10/652; H01M 10/653; H01M 10/6552; H01M 10/6563; H01M 50/247; H01M 50/256; H01M 50/293

(52) U.S. Cl. CPC H01M 10/6551; H01M 10/623; H01M 10/652; H01M 10/653; H01M 10/6552; H01M 10/6563; H01M 50/247; H01M 50/256; H01M 50/293; H01M 2220/30

(57) ABSTRACT

Cases can couple to a battery device to be held within the case. The case can include features, such as a clip with a heat sink, for dissipating heat away from the battery device while the case is within a pocket of a user. Such features can promote heat dissipation for the battery device even while the battery device is within an enclosed environment. The clip can serve as a mechanical engagement feature as well as a thermal dissipation feature. The clip can conduct heat away from the battery device and into an external environment, providing improved heat dissipation for the battery device and reducing the need for power throttling.

### TECHNICAL FIELD

The present description relates generally to cases, and, more particularly, to cases that provide thermal management for electronic devices.

### BACKGROUND

Portable electronic devices (e.g., wearable devices, mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, may require the portable electronic device to be physically tethered to a power outlet.

### BRIEF DESCRIPTION OF THE DRAWINGS

Certain features of the subject technology are set forth in the appended claims.

However, for purpose of explanation, several embodiments of the subject technology are set forth in the following figures.

FIG. 1 illustrates a perspective view of a system including an external device, a case, and a battery device, in accordance with embodiments of the present disclosure.

FIG. 2 illustrates a perspective view of the system of FIG. 1 with the external device, the case, and the battery device in an assembled configuration, in accordance with embodiments of the present disclosure.

FIG. 3 illustrates a side sectional view of a case containing a battery device while within a pocket, in accordance with embodiments of the present disclosure.

FIG. 4 illustrates a side sectional view of a case containing a battery device while within a pocket, in accordance with embodiments of the present disclosure.

FIG. 5 illustrates a sectional view of a portion of the case of FIG. 4, in accordance with embodiments of the present disclosure.

FIG. 6 illustrates a sectional view of another portion of the case of FIG. 4, in accordance with embodiments of the present disclosure.

FIG. 7 illustrates a side sectional view of a case containing a battery device while within a pocket, in accordance with embodiments of the present disclosure.

FIG. 8 illustrates a front view of a case and a battery device, in accordance with embodiments of the present disclosure.

FIG. 9 illustrates a side sectional view of a case containing a battery device, in accordance with embodiments of the present disclosure.

FIG. 10 illustrates a side sectional view of a case for containing a battery device, in accordance with embodiments of the present disclosure.

FIG. 11 illustrates a block diagram of a system including an external device and a battery device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Portable electronic devices (e.g., wearable devices, mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, may require the portable electronic device to be physically tethered to a power outlet.

It can be beneficial to allow a user to select a battery device for use with an external device to extend and/or customize the user experience according to the user's desires. Such a battery device can generate heat during use. In certain battery devices, the power output of the battery device is limited (e.g., throttled) to maintain its temperature below certain levels. Such power throttling can result in a reduction in the maximum sustainable power of the external device that is supported by the battery device. The external device may then modify its performance accordingly (e.g., frame drops, decreased framerates, etc.). These modifications can detract from the user's experience with the external device.

In some use cases, the battery device may be held in a pocket or other enclosed space that limits opportunities for dissipating heat. In such an environment, the battery device is less efficient at dissipating its own heat due to reduced convective cooling, insulation from the users clothing, and increased local ambient temperatures from the user's body temperature. Accordingly, the battery device's temperature may be higher when carried in a pocket or other insulated environment and could require power throttling to maintain thermal conditions within targeted ranges.

Cases, such as those described herein, can couple to a battery device to be held within the case. The case can include features, such as a clip with a heat sink, for dissipating heat away from the battery device while the case is within a pocket of a user. Such features can promote heat dissipation for the battery device even while the battery device is within an enclosed environment. The clip can serve as a mechanical engagement feature as well as a thermal dissipation feature. The clip can conduct heat away from the battery device and into an external environment, providing improved heat dissipation for the battery device and reducing the need for power throttling.

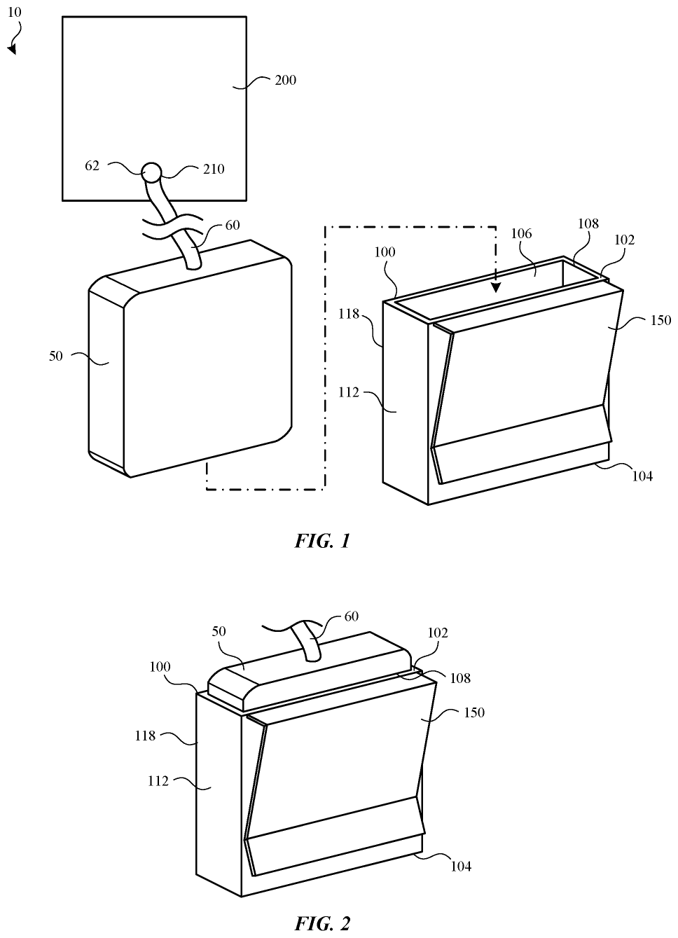

These and other embodiments are discussed below with reference to FIGS. 1-11. However, those skilled in the art will readily appreciate that the detailed description given herein with respect to these Figures is for explanatory purposes only and should not be construed as limiting.

Referring now to FIGS. 1 and 2, a system 10 can include a case 100, an external device 200, and a battery device 50. The battery device 50 can be physically and/or operably connected or connectable to an external device 200 for providing functions thereto.

In some embodiments, the battery device 50 can be a device that can be held or carried by a user. In some embodiments, the battery device 50 can be a wearable device that is worn optionally near the external device 200. The battery device 50 can be worn on a head, neck, ear, shoulders, and/or other portion of the user and/or the user's clothing (e.g., pocket). The battery device 50 can include a securement element to secure the battery device 50 to or near a user and/or the external device 200.

The external device 200 can be one or more of a variety of electronic devices. In some embodiments, the external device 200 can include wearable devices, such as watches, health monitoring devices, head-mountable devices, earpiece devices, and the like. In some embodiments, the external device 200 can include portable devices, such as smartphones, tablet computers, laptops, and the like. It will be understood that the external device 200 be one or more of a variety of devices, including one of multiple devices to which the battery device 50 can be connected at different occasions.

The external device 200 can be provided with a connection to the attachable, removable, and/or exchangeable battery device 50, which can provide a variety of different components and functions to achieve the results that are desired by a user. As shown in FIG. 1, the battery device 50 can be separate from but connectable to the external device 200. The external device 200 can include one or more external device connectors 210 for mechanically and operably (e.g., communicatively) connecting to the battery device 50. The battery device 50 can include a tether 60 with a tether connector 62. The tether connector 62 can be configured to mechanically and operably (e.g., communicatively) connect to the external device 200 via the external device connector 210. Attachment can be achieved with an engagement that holds the tether connector 62 of the battery device 50 in place relative to the external device 200 until release (e.g., by the user). In some embodiments, while the tether connector 62 engages the external device connector 210, the tether connector 62 can rotate with respect to the battery device 50 while maintaining engagement therewith and/or a communication link. Such rotation can help relieve torque applied at the interface between the tether connector 62 and the external device connector 210. In some embodiments, while the tether connector 62 engages the external device connector 210, the tether connector 62 can maintain a fixed position and/or orientation with respect to the battery device 50.

The external device 200 can be provided with one or more battery devices 50 for further enhancing functionality of the external device 200. While a single battery device 50 is shown, it will be understood that the description herein can apply to any number of battery devices 50 simultaneously or alternately connected to the external device 200.

The battery device 50 can include one or more battery device components that provide functions to the external device 200 when connected thereto, as described herein. An electrical or other communication connection can be made and maintained upon mechanical securement of the external device connectors 210 and the tether connector 62, for example via corresponding communication interfaces. When the external device 200 is connected to the battery device 50, components of both can be in operative communication with each other. For example, components of the battery device 50 can be in operative communication with components of the external device 200.

It will be understood that the external device 200 can be operable with or without use of the battery device 50 and that the battery device 50 can provide additional functionality to the external device 200 when installed. Connection of a battery device 50 with an external device 200 can be performed and reversed, followed by disconnection and connection of another battery device 50 with the same external device 200 or another external device 200 with the same battery device 50. As such, multiple battery devices 50 can be exchangeable with each other with respect to a given external device 200. Further, multiple external devices 200 can be exchangeable with each other with respect to a given battery device 50.

A battery device 50 can be connected to an external device 200 in a manner that allows the battery device 50 to be removed thereafter. The connection can be fully reversible, such that when the battery device 50 and the external device 200 are disconnected, each is restored to a condition held prior to the connection. The connection can be fully repeatable, such that after the battery device 50 and the external device 200 are disconnected, the same or a different external device 200 and battery device 50 pair can be connected in the same way. The battery device 50 and external device 200 can be securely and temporarily connected, rather than permanently, fixedly, or resiliently connected (e.g., via chemical and/or molecular bond). For example, connection and disconnection of the battery device 50 and external device 200 are facilitated in a manner that does not cause permanent damage, harm, or deformation to the battery device 50 or the external device 200.

The case 100 may be any device that couples to the battery device 50. The case 100 may define or include a cavity 106 for receiving and retaining at least a portion of the battery device 50. In some embodiments, the cavity 106 can be any space that is partially or entirely enclosed by the case 100. Accordingly, the cavity 106 can be formed by a structure that either partially or entirely encloses a space in which the battery device 50 can be received. The case body 118 of the case 100 can receive at least a portion of the battery device 50 through at least the first end 102 of the case 100 with an opening 108 thereat. For example, the case body 118 of the case 100 can provide a cavity 106 into which a portion or the entirety of battery device 50 may be placed. The cavity 106 may be defined, at least in part, by the case body 118 that surround some portion of the battery device 50 (e.g., exterior surfaces), for example, with sidewalls 112. The cavity 106 can extend from the opening 108 at the first end 102 of the case 100 toward a second end 104, opposite the first end 102.

As shown in FIG. 2, the case 100 and the battery device 50 can be temporarily and securely coupled together to form an integrated unit, which can be compactly stowed. As shown, the battery device 50 can be stored in the cavity of the case 100 through the opening 108 thereto. In such an arrangement, the tether 60 of the battery device 50 can continue to extend to an external device (not shown in FIG. 2). As an integrated unit, the case 100 and the battery device 50 can remain together so the user has fewer separate objects to gather and maintain. Instead, the user can easily transport and store the integrated system.

In one example, the case body 118 can have portions formed by sidewalls 112 of the case 100 and can optionally extend about a periphery of the battery device 50. The cavity 106 may be further defined, at least in part, by a portion of the case body 118 that provides a surface along the sidewalls 112 of the case 100. In some embodiments, the sidewalls 112 can be between the first end 102 and the second end 104 of the case 100 at the case body 118 and can extend about at least a portion of the periphery of the battery device 50. The cavity 106 may optionally include one or more retention features for holding and securing the battery device 50 within the cavity 106, as described further herein. For example, the retention features may include elastic layers, foam, rails, channels, snaps, detents, latches, catches, magnets, friction couplings, doors, locks, flexures, and the like. It will be understood that coupling between the case 100 and the battery device 50 can be secure, such that the case 100 and the battery device 50 are not inadvertently separated during use. It will be further understood that the case 100 and the battery device 50 can be removably coupled, such that the battery device 50 can be removed from the case 100 as desired by a user. As such, the coupling between the case 100 and the battery device 50 can be reversible, such that each can be restored to a state prior to any coupling there between.

In some embodiments, the case 100 can further include a clip 140 extending from the case body 118. For example, the clip 140 can extend from the case body 118 at the first end 102. The clip 140 can further extend alongside one or more of the sidewalls 112 and/or toward a second then 104 of the case 100. In general, the clip 140 can define a space alongside one or more of the sidewalls 112. In some embodiments, the clip 140 can be biased toward the case body 118, for example to capture and press against a structure placed there between.

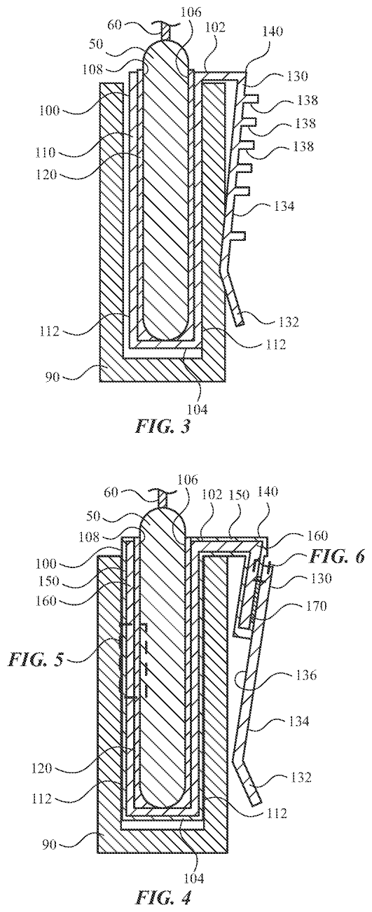

Referring now to FIG. 3, a case can hold a battery device and manage heat generated by the battery device. As shown in FIG. 3, the case 100 can include a case body 118 for holding a battery device 50 and a clip 140 for dissipating heat generated by the battery device 50. The case 100, for example at the case body 118, can include an outer housing 110 forming an opening 108 at a first end 102 of the case 100. The case 100, for example at the case body 118, can form a cavity 106 extending from the opening 108 and within the outer housing 110 toward a second end 104 of the case 100. The battery device 50 can be inserted through the opening 108 and into the cavity 106 to be secured within the case body 118 of the case 100. The outer housing 110 can be of a metal or another material having high thermal conductivity. The material can provide high rigidity and strength to provide support to the case 100 and/or its contents.

The case 100 can further include an elastic layer 120 within the outer housing 110 and extending along inner walls of the outer housing 110. The outer housing 110 can extend continuously about the elastic layer 120 and the cavity 106 between the first end 102 and the second end 104. The elastic layer 120 can define the inner periphery of the cavity 106. For example, the elastic layer 120 can abut the battery device 50 when placed within the cavity 106. When receiving the battery device 50, the elastic layer 120 can be compressed against the inner walls (e.g., sidewalls 112) of the outer housing 110. As such, the elastic layer 120 can apply a biasing force against the battery device 50 with friction to help retain the battery device 50 within the cavity 106. The elastic layer 120 can include one or more of a variety of materials to provide such biasing under compression. For example, the elastic layer 120 can include a foam structure, an elastomer, a matrix material, or another material having elastic properties. Furthermore, the elastic layer 120 can be compressed to engage against the battery device 50 for high thermal contact. In some embodiments, the elastic layer 120 can include a thermally conductive material, such as a thermally conductive foam.

The case 100 can further include a clip 140 for securing the case 100 and/or dissipating heat. The clip 140 can extend from the first end 102 of the case 100, away from the case body 118 (e.g., at the outer housing 110), and toward the second end 104 of the case 100, for example alongside one or more of the sidewalls 112. The clip 140 can form a heat sink 130 that is thermally conductive to draw heat away from the battery device 50. The heat sink 130 can be thermally connected to the case body 118, for example at the outer housing 110.

To facilitate dissipation of heat, the heat sink 130 can be positioned alongside the sidewall 112, so that the clip 140, including the heat sink 130, can be positioned outside of a pocket 90 or another container for the case body 118 and the battery device 50. While the case body 118 and the battery device 50 are within the pocket 90, the user can securely carry the case 100. Further, the tether 60 can extend out of the pocket 90 to connect to the external device (not shown). The clip 140 can be positioned on an exterior of the pocket 90 for securement thereto and for dissipating heat away from the user and toward an external environment. In some embodiments, the heat sink 130 can include a plurality of fins 138 positioned in an air flow path so as to increase a surface area of the outer surface 134 of the heat sink 130, which can be exposed to the flow of air and/or an external environment. The fins 138 can be of any shape, number, orientation, and size. For example, the fins 138 can include any protrusion from and/or recess into the outer surface 134 of the heat sink 130.

In some embodiments, the heat sink 130, optionally including the fins 138, and the outer housing 110 can be formed as a monolithic structure, rather than an assembly of parts. As used herein, a monolithic structure is one that is integrally formed of a single piece of material, rather than of separate pieces that are joined together by an interface. For example, the heat sink 130, optionally including the fins 138, can be a unibody and/or unitary structure along with the outer housing 110 of the case body 118. By providing a monolithic, unitary, and/or unibody structure, the heat sink 130 and the outer housing 110 need not contain interfaces or discontinuities, such as those that occur in assembled parts. Accordingly, the monolithic, unitary, and/or unibody structure can be fabricated to more precise and consistent dimensions as well as provide greater structural support and thermal conductivity.

In some embodiments, the heat sink 130 can be thermally coupled to the outer housing 110 and/or another structure of the case body 118 via a thermal interface (not shown), such as a thermally conductive adhesive or another appropriate thermally conductive material, to enhance heat transfer (e.g., conduction) from the case body 118 within the pocket 90 through the heat sink and to the stream of air and/or the external environment outside of the pocket 90.

In some embodiments, the heat sink 130, optionally including the fins 138, and the outer housing 110 can be of a metal or another material having high thermal conductivity. In some embodiments, a material is thermally conductive if it has a thermal conductivity greater than 1 W·m⁻¹·K⁻¹. The material can provide high rigidity and strength to provide support to the battery device 50 and to securely mount to the pocket 90 (e.g., with the clip 140).

Referring now to FIGS. 4-6, a case can hold a battery device and manage heat generated by the battery device. As shown in FIG. 4, the case 100 can include a case body 118 for holding a battery device 50 and a clip 140 for dissipating heat generated by the battery device 50. The case 100, for example at the case body 118, can include an outer housing 150 forming an opening 108 at a first end 102 of the case 100. The case 100, for example at the case body 118, can form a cavity 106 extending from the opening 108 and within the outer housing 150 toward a second end 104 of the case 100. The battery device 50 can be inserted through the opening 108 and into the cavity 106 to be secured within the case body 118 of the case 100. The outer housing 150 can be of a plastic, a resin (e.g., epoxy), a polymer, or another material having high thermal insulation or low thermal conductivity. In some embodiments, a material is thermally insulative if it has a thermal conductivity less than 1 W·m⁻¹·K⁻¹. The material can provide high rigidity and strength to provide support to the case 100 and/or its contents.

The case 100 can further include a heat pipe 160 within the outer housing 150 and extending along inner walls of the outer housing 150. The heat pipe 160 can provide thermal conduction to draw heat away from the battery device 50 and toward the clip 140. In some embodiments, the heat pipe 160 can be of a metal or another material having high thermal conductivity. In some embodiments, the heat pipe 160 can have a thermal conductivity that is higher than a thermal conductivity of the outer housing 150. As such, heat can be directed away from the battery device 50 (e.g., toward the clip 140) by the heat pipe 160 while also being shielded from the user by the outer housing 150. In some embodiments, the portion of the heat pipe 160 at the case body 118 can be entirely surrounded by the outer housing 150, such that the heat pipe 160 is not exposed to the external environment (e.g., the pocket 90 and/or the user).

The case 100 can further include an elastic layer 120 within the outer housing 150 and the heat pipe 160 and extending along inner walls of the heat pipe 160. The outer housing 150 and/or the heat pipe 160 can extend continuously about the elastic layer 120 and the cavity 106 between the first end 102 and the second end 104. The elastic layer 120 can define the inner periphery of the cavity 106. For example, the elastic layer 120 can abut the battery device 50 when placed within the cavity 106. When receiving the battery device 50, the elastic layer 120 can be compressed against the inner walls (e.g., sidewalls 112) of the heat pipe 160 and/or the outer housing 150. As such, the elastic layer 120 can apply a biasing force against the battery device 50 with friction to help retain the battery device 50 within the cavity 106. The elastic layer 120 can include one or more of a variety of materials to provide such biasing under compression. For example, the elastic layer 120 can include a foam structure, an elastomer, a matrix material, or another material having elastic properties. Furthermore, the elastic layer 120 can be compressed to engage against the battery device 50 for high thermal contact. In some embodiments, the elastic layer 120 can include a thermally conductive material, such as a thermally conductive foam. In some embodiments, the heat pipe 160 can have a modulus of elasticity that is higher than a modulus of elasticity of the elastic layer 120.

The case 100 can further include a clip 140 for securing the case 100 and/or dissipating heat. The clip 140 can extend from the first end 102 of the case 100, away from the case body 118 (e.g., at the outer housing 150), and toward the second end 104 of the case 100, for example alongside one or more of the sidewalls 112 with an inner surface 136 of the clip 140 facing the case body 118. In some embodiments, the outer housing 150 and/or the heat pipe 160 can extend from the case body 118 to form at least a portion of the clip 140. As such, the structures can be monolithic and continuous between the case body 118 and the clip 140.

The clip 140 can form a heat sink 130 that is thermally conductive to draw heat away from the battery device 50. The heat sink 130 can be thermally connected to the case body 118, for example at the outer housing 150 and/or the heat pipe 160. To facilitate dissipation of heat, the heat sink 130 can be positioned alongside the sidewall 112, so that the clip 140, including the heat sink 130, can be positioned outside of a pocket 90 or another container for the case body 118 and the battery device 50. While the case body 118 and the battery device 50 are within the pocket 90, the user can securely carry the case 100. Further, the tether 60 can extend out of the pocket 90 to connect to the external device (not shown). The clip 140 can be positioned on an exterior of the pocket 90 for securement thereto and for dissipating heat away from the user and toward an external environment. In some embodiments, the heat sink 130 can include a plurality of fins (not shown) positioned in an air flow path so as to increase a surface area of the outer surface 134 of the heat sink 130, which can be exposed to the flow of air and/or an external environment.

In some embodiments, the heat sink 130 can be thermally coupled to the heat pipe 160 and/or another structure of the case body 118 via a thermal interface 170, such as a thermally conductive adhesive or another appropriate thermally conductive material, to enhance heat transfer (e.g., conduction) from the case body 118 within the pocket 90 through the heat sink 130 and to the stream of air and/or the external environment outside of the pocket 90. For example, the heat sink 130 can be coupled to the heat pipe 160 with the thermal interface 170 at a portion of the heat pipe 160 that is exposed by the outer housing 150. The thermal interface 170 and the outer housing 150 can surround the heat pipe 160 so that no portion thereof is exposed to an external environment, thereby limiting galvanic corrosion of the heat pipe 160. By providing a thermal interface 170, the heat pipe 160 and the heat sink 130 can be of different materials. For example, the heat pipe 160 can have a thermal conductivity that is higher than a thermal conductivity of the heat sink 130. By further example, the heat pipe 160 can protected by the outer housing 150 and the thermal interface 170, and the heat sink 130 can be of a material selected to endure exposure to an external environment.

In some embodiments, the heat sink 130 and the heat pipe 160 can be formed as a monolithic structure, rather than an assembly of parts. For example, the heat sink 130 can be a unibody and/or unitary structure along with the heat pipe 160 of the case body 118. By providing a monolithic, unitary, and/or unibody structure, the heat sink 130 and the heat pipe 160 need not contain interfaces or discontinuities, such as those that occur in assembled parts. Accordingly, the monolithic, unitary, and/or unibody structure can be fabricated to more precise and consistent dimensions as well as provide greater structural support and thermal conductivity.

In some embodiments, the heat sink 130, optionally including the fins, and the heat pipe 160 can be of a metal or another material having high thermal conductivity. The material can provide high rigidity and strength to provide support to the battery device 50 and to securely mount to the pocket 90 (e.g., with the clip 140). a clip 140 formed by:

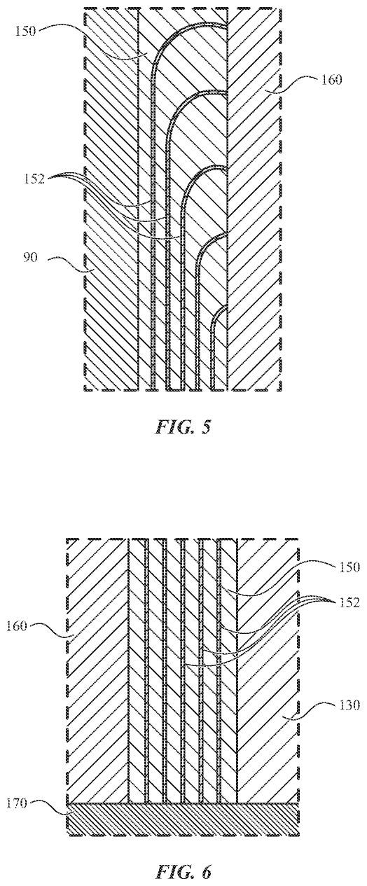

As shown in FIGS. 5 and 6, the outer housing 150 include features that promote thermal management. In some embodiments, the outer housing 150 can include or contain one or more thermally conductive wires 152. The wires 152 can extend within the outer housing 150 from the heat pipe 160 to the heat sink 130 of the clip 140. For example, each of the wires 152 can include a first end or other portion that is in direct contact with the heat pipe 160 and a second end or other portion that is in direct contact with the thermal interface 170 and/or the heat sink 130. While the outer housing 150 can be thermally insulative, the wires 152 can be of a metal or another material having high thermal conductivity. This can provide additional thermal pathways from the heat pipe 260 to the thermal interface 170 and/or the heat sink 130 while maintaining thermal insulation at the outer housing 150 to direct heat away from the pocket and the user.

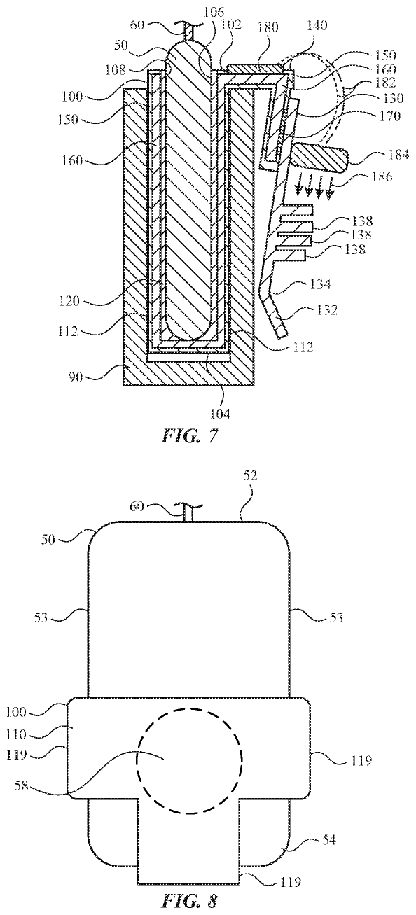

Referring now to FIG. 7, a case can hold a battery device and manage heat generated by the battery device. The items illustrated in FIG. 7 can be considered similar to those depicted in FIGS. 4-6. As such, the items illustrated in FIG. 7 can include one or more of the features described herein with respect to FIGS. 4-6 except where described otherwise herein. It will be understood that the features of FIG. 7 can be combined with and/or include with one or more of the features described herein with respect to FIG. 3.

As shown in FIG. 7, the case 100 can include a case body 118 and a clip 140 for securing the case 100 and/or dissipating heat from a battery device 50 within the case body 118. The clip 140 can extend from the first end 102 of the case 100, away from the case body 118 (e.g., at the outer housing 150), and toward the second end 104 of the case 100, for example alongside one or more of the sidewalls 112 with an inner surface 136 of the clip 140 facing the case body 118.

The clip 140 can form a heat sink 130 that is thermally conductive to draw heat away from the battery device 50. The heat sink 130 can be thermally connected to the case body 118, for example at the outer housing 150 and/or the heat pipe 160. In some embodiments, the heat sink 130 can include a plurality of fins 138 positioned in an air flow path so as to increase a surface area of the outer surface 134 of the heat sink 130, which can be exposed to the flow of air and/or an external environment. The fins 138 can be of any shape, number, orientation, and size. For example, the fins 138 can include any protrusion from and/or recess into the outer surface 134 of the heat sink 130.

The case 100 can further include a fan 184 configured to direct air across the heat sink 130 and/or between the multiple fins 138. For example, the fan can be positioned and arranged to direct air from the external environment across the outer surface 134 of the heat sink 130. The air can cool the heat sink 130 and/or the fins 138 thereof as the heat sink 130 receives heat from the case body 118 (e.g., via an outer housing, wires, heat pipe, and/or thermal interface).

The clip 140 can be positioned on an exterior of the pocket 90 for securement thereto and for dissipating heat away from the user and toward an external environment. In some embodiments, the heat sink 130 can include a plurality of fins 138 positioned in an air flow path from the fan 184 so as to increase a surface area of the outer surface 134 of the heat sink 130, which can be exposed to the flow of air from the fan 184 and/or an external environment.

In some embodiments, the fan 184 can be powered by a thermoelectric generator 180. The thermoelectric generator 180 can include, for example, a solid state device that converts heat flux (temperature differences) into electrical energy. In some embodiments, the thermoelectric generator 180 can be coupled to the heat pipe 160 and configured to control operation of the fan 184 based on a temperature difference between the heat pipe 160 and an ambient environment external to the case 100. For example, when the temperature difference between the heat pipe 160 and the ambient environment external to the case 100 is high, the thermoelectric generator 180 can generate relatively more electrical energy to operate the fan 184 at a higher level (e.g., to generate more or faster air flow). By further example, when the temperature difference between the heat pipe 160 and the ambient environment external to the case 100 is low, the thermoelectric generator 180 can generate relatively less electrical energy to operate the fan 184 at a lower level (e.g., to generate less or slower air flow). By further example, when the temperature of the heat pipe 160 and the ambient environment external to the case 100 is the same (i.e., no temperature difference), the thermoelectric generator 180 can generate no electrical energy and thereby cease operation of the fan 184. While the thermoelectric generator 180 is illustrated as being coupled to the heat pipe 160, it will be understood that the thermoelectric generator 180 can additionally or alternatively to coupled to one or more other structures of the case 100, including any structure that is thermally coupled to the battery device 50 when held by the case 100. In some embodiments, the fan 184 can optionally be powered by the battery device 50 and/or another power source.

Referring now to FIG. 8, a case 100 can include a form factor with features to selectively cover and couple to portions of a battery device 50. As shown in FIG. 8, a case 100 can cover portions of the battery device 50, but leave other portions exposed. For example, the case 100 (e.g., the outer housing 110 thereof) can leave exposed at least a portion of one or more of a first end 52 of the battery device 50 (e.g., having the tether 60), a second end 54 of the battery device 50, and/or one or more sidewalls 53 of the battery device 50.

As shown in FIG. 8, a battery device 50 may generate heat in relatively greater abundance in certain portions thereof, such as region 58. The case 100 can be provided to target such a region 58 while otherwise leaving the battery device 50 uncovered. For example, the case 100 can include an outer housing 110 that overlaps the region 58 of the battery device 50 when coupled thereto. The outer housing 110 can further include one or more extensions 119 that extend from a portion of the outer housing 110 that covers the region 58. The extensions 119 can surround a portion of the battery device 50 for holding the battery device 50. For example, the extensions 119 can extend about and/or to the second end 54 and/or the sidewalls 53. The extension 119 can extend in different directions from the region 58 to surround the battery device 50. The outer housing 110 can be of a metal or another material having high thermal conductivity. The material can provide high rigidity and strength to provide support to the case 100 and/or its contents. Apart from the outer housing 110 and the extensions 119, the case 100 leave uncovered and/or exposed other portions of the battery device 50, such as those that are known to generate relatively less heat.

The case 100 can further include an elastic layer (e.g., within the outer housing 110), a clip (e.g., extending from a side of the outer housing 110), a heat sink, and/or other structures described herein. The case 100 can be positioned partially within a pocket and partially outside of the pocket or another container for the battery device 50. While the case 100 and the battery device 50 are within the pocket, the user can securely carry the case 100. Further, the tether 60 can extend out of the pocket to connect to the external device (not shown). The clip can be positioned on an exterior of the pocket for securement thereto and for dissipating heat away from the user and toward an external environment.

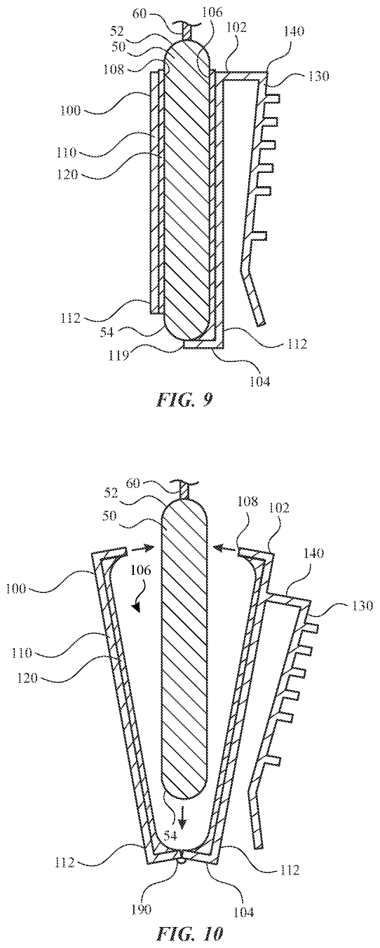

Referring now to FIG. 9, a case 100 can include a form factor with features to selectively cover and couple to portions of a battery device 50. The case 100 can include one or more features in common with the case 100 of FIG. 8 and/or one or more other cases described herein. For example, the case 100 can include an outer housing 110, an elastic layer 120, a clip 140, and/or a heat sink 130. By further example, the case 100 of FIG. 9 can cover some portions of the battery device 50, but leave other portions exposed. For example, the case 100 (e.g., the outer housing 110 thereof) can leave exposed at least a portion of one or more of a first end 52 of the battery device 50 (e.g., having the tether 60) and/or a second end 54 of the battery device 50.

In some embodiments, one or more extensions 119 of the case 100 can surround a portion of the battery device 50 for holding the battery device 50. For example, an extension 119 can extend about and/or to the second end 54 of the battery device 50 and form the second end 104 of the case 100. Such a second end 104 can provide a stopper against which the second end 54 of the battery device 50 can abut when inserted through the opening 108 and into the cavity 106 of the case 100. Accordingly, the cavity 106 of the case 100 can be a partial cavity 106 that partially encloses the battery device 50 while allowing other portions thereof to remain exposed.

The outer housing 110 can be of a metal or another material having high thermal conductivity. The material can provide high rigidity and strength to provide support to the case 100 and/or its contents. Apart from the outer housing 110 and the extensions 119, the case 100 leave uncovered and/or exposed other portions of the battery device 50, such as those that are known to generate relatively less heat. The case 100 can further include an elastic layer (e.g., within the outer housing 110), a clip 140 (e.g., extending from a side of the outer housing 110), a heat sink 130, and/or other structures described herein.

Referring now to FIG. 9, a case 100 can include a form factor with features to controllably cover and couple to portions of a battery device 50. The case 100 can include one or more features in common with one or more other cases described herein. For example, the case 100 can include an outer housing 110, an elastic layer 120, a clip 140, and/or a heat sink 130.

In some embodiments, the case 100 can be opened to receive the battery device 50. For example, separate portions of the case 100 can be connected to each other by a hinge 190 or other mechanism to facilitate relative movement and/or rotation. The movement about the hinge 190 can allow the opening 108 to appear and/or enlarge to allow passage of the battery device 50 there through. Reverse movement can allow the case 100 to close around the battery device 50, optionally surrounding at least a portion of the first end 52 and the second end 54 of the battery device 50. In some embodiments, the first end 102 of the case 100 can prevent removal of the battery device 50 from the cavity 106 until the case is opened with movement about the hinge 190. In some embodiments, the first end 102 of the case 100 can allow the tether 60 to extend there through when the case 100 is closed. Accordingly, the cavity 106 of the case 100 can optionally fully enclose the battery device 50 (e.g., other than at the tether 60) while providing a mechanism for providing access thereto when desired.

The outer housing 110 can be of a metal or another material having high thermal conductivity. The material can provide high rigidity and strength to provide support to the case 100 and/or its contents, including when the case 100 transitions between an open configuration and a closed configuration. The case 100 can further include an elastic layer (e.g., within the outer housing 110), a clip 140 (e.g., extending from a side of the outer housing 110), a heat sink 130, and/or other structures described herein.

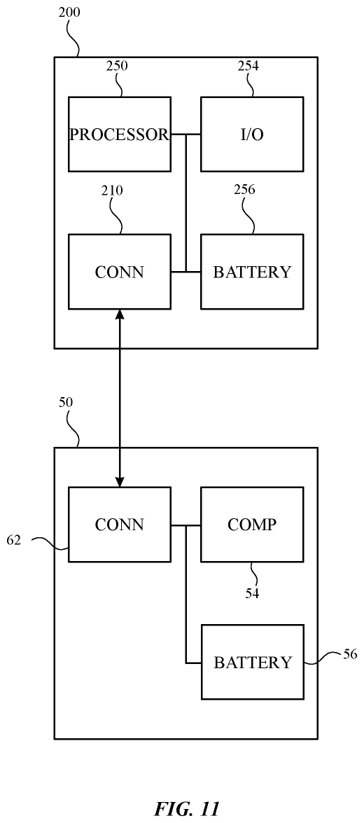

FIG. 11 illustrates a block diagram of a system including a battery device and an external device, in accordance with some embodiments of the present disclosure. It will be appreciated that components described herein can be provided on any one or more of the battery device and the external device. In some embodiments, components are provided by either or both of the battery device and the external device to reduce redundancy and increase customization, for example based on a selection of a battery device.

The external device 200 can include a processor 250 with one or more processing units that include or are configured to access a memory having instructions stored thereon. The instructions or computer programs may be configured to perform one or more of the operations or functions described with respect to the corresponding device. The processor 250 can be implemented as any electronic device capable of processing, receiving, or transmitting data or instructions. For example, the processor 250 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The memory can store electronic data that can be used by the external device 200. For example, the memory can store electrical data or content such as, for example, audio and video files, documents and applications, device settings and user preferences, timing and control signals or data for the various modules, data structures or databases, and so on. The memory can be configured as any type of memory. By way of example only, the memory can be implemented as random access memory, read-only memory, Flash memory, removable memory, or other types of storage elements, or combinations of such devices.

The battery device 50 and/or the external device 200 can include a battery (e.g., batteries 256 and/or 56). Such batteries can store power for use by the corresponding device and/or for transfer to another connected device, as described herein.

The battery device 50 and/or the external device 200 can include an input/output component (e.g., I/O components 254), which can include any suitable component for providing a user interface for operation by a user. The input/output component can include buttons, keys, touchscreens, microphones, speakers, displays, and/or another feature that can be operated by the user. The input and/or the output can be tactile, auditory, visual, and the like.

Where the battery device 50 and the external device 200 are connected with a communication interface, such devices can communicate with each other and/or one or more other devices using any suitable communications protocol. For example, the tether connector 62 and/or the external device connector 210 can include a communications interface that supports Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communications interface can also include an antenna for transmitting and receiving electromagnetic signals. Such interfaces (e.g., via connectors) can transmit power, signals, commands, and the like.

In some embodiments, the battery device 50 can operate as a power source for the external device 200. By providing power with a removable battery device, the user can select such a battery device according to anticipated power needs. The battery 56 can include a battery that is used to store and provide power to the external device 200 and/or the battery device 50. Optionally, the battery device 50 can recharge the battery 256 of the external device 200, for example, by directing power from the battery 56 across the corresponding connectors. Other pathways are contemplated, such as another link or wireless charging. As such, power transfer can be wired and/or wireless. The battery can be a replaceable battery, a rechargeable battery.

Other components of the various devices can add functions and/or operations to other connected devices. For example, the battery device component 54 of the battery device 50 can be or include one or more of a variety of electronic components that are operable with or without connection to another device. For example, one or more components can include speakers, cameras, microphones, environment sensors, bio-sensors, user sensors, displays, input devices, display drivers, and the like. Each of The battery device 50 and/or the external device 200 can include any number of components. By providing components on separate devices, the user can optionally provide an appropriate device when selected functions are desired. At other times, other devices or no device can be selected, thereby reducing the need to have all features available at all times.

Additionally or alternatively, the external device 200 can alter one or more parameters of its operations based on the presence, absence, or another condition of the battery device 50. For example, when the battery device 50 is connected, the external device 200 may perform an action that utilizes the functions of the battery device 50. By further example, when the battery device 50 is absent, the external device 200 may perform an action that does not rely on the functions of the battery device 50. Additionally or alternatively, the external device 200 may perform actions in a manner that consumes power based on the presence, absence, and/or amount of power provided by a battery device 50. For example, the external device 200 can perform an action with greater power consumption (e.g., high-resolution display output, enhanced audio and/or imaging processing, communication with one or more devices, downloading data, processing data, archiving data, etc.) when a battery of the battery device 50 is present and sufficiently charged. By further example, the external device 200 can perform an action with lower power consumption (e.g., low-resolution display output, reduced audio and/or imaging processing, reduced communication with battery devices) or refrain from performing one or more actions (e.g., communication with one or more devices, downloading data, processing data, archiving data, etc.) when a battery of the battery device 50 is absent or not sufficiently charged.

The battery device 50 can be configured to interact with at least one other device other than the external device 200. For example, the battery device 50 can be charged by an external device with a power source, so that the battery 56 of the battery device 50 carries a charge for transfer to the external device 200.

Various examples of aspects of the disclosure are described below as clauses for convenience. These are provided as examples, and do not limit the subject technology.

Clause A: a case for a battery device, the case comprising: an outer housing forming an opening at a first end of the case and forming a cavity extending from the opening and within the outer housing toward a second end of the case; and an elastic layer within the outer housing and extending along inner walls of the outer housing; and a clip extending from the first end of the case, away from the outer housing, and toward the second end of the case, the clip forming a heat sink with multiple fins on an outer surface of the clip.

Clause B: a case for a battery device, the case comprising: an outer housing forming an opening at a first end of the case and forming a cavity extending from the opening and within the outer housing toward a second end of the case, wherein the outer housing comprises a thermally insulative material; a heat pipe extending within the outer housing, wherein the outer housing comprises a thermally conductive material; and a clip formed by: a portion of the heat pipe extending from the first end of the case and a portion of the outer housing; and a heat sink extending toward the second end of the case and being thermally coupled to the heat pipe.

Clause C: a case for a portable electronic device and a battery device, the case comprising: an outer housing forming an opening at a first end of the case and forming a cavity extending from the opening and within the outer housing toward a second end of the case, wherein the outer housing comprises a thermally insulative material; a heat pipe extending within the outer housing, wherein the outer housing comprises a thermally conductive material; a clip extending from the first end of the case, away from the outer housing, and toward the second end of the case; and a fan configured to direct air across an outer surface of the clip.

One or more of the above clauses can include one or more of the features described below. It is noted that any of the following clauses may be combined in any combination with each other, and placed into a respective independent clause, e.g., Clause A, B, or C.

Clause 1: a fan configured to direct air across the outer surface of the clip.

Clause 2: the elastic layer comprises a thermally conductive foam.

Clause 3: a heat pipe extending within the outer housing, wherein the outer housing comprises a thermally conductive material, wherein the outer housing comprises a thermally insulative material, and wherein the heat sink is thermally coupled to the heat pipe.

Clause 4: the heat sink is coupled to the heat pipe by a thermal interface material extending from the heat pipe and through the outer housing.

Clause 5: thermally conductive wires extending within the outer housing from the heat pipe to the heat sink of the clip.

Clause 6: a fan configured to direct air between the multiple fins.

Clause 7: the outer housing extends continuously about the elastic layer and the cavity between the first end and the second end.

Clause 8: the heat sink is coupled to the heat pipe by a thermal interface material extending from the heat pipe and through the outer housing.

Clause 9: an elastic layer within the outer housing and extending along inner walls of the outer housing.

Clause 10: the heat sink forms multiple fins on an outer surface of the clip.

Clause 11: a thermoelectric generator coupled to the heat pipe and configured to control operation of the fan based on a temperature gradient between the heat pipe and an ambient environment external to the case.

Clause 12: the clip comprises a heat sink coupled to the heat pipe by a thermal interface material extending from the heat pipe and through the outer housing.

Clause 13: the clip comprises a heat sink that forms multiple fins on the outer surface of the clip, wherein the fan is configured to direct the air between the multiple fins.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A case for a battery device, the case comprising:
an outer housing forming an opening at a first end of the case and forming a cavity extending from the opening and within the outer housing toward a second end of the case; and
an elastic layer within the outer housing and extending along inner walls of the outer housing; and
a clip extending from the first end of the case, away from the outer housing, and toward the second end of the case, the clip forming a heat sink with multiple fins on an outer surface of the clip.

2. The case of claim 1, further comprising a fan configured to direct air across the outer surface of the clip.

3. The case of claim 1, wherein the elastic layer comprises a thermally conductive foam.

4. The case of claim 1, further comprising a heat pipe extending within the outer housing, wherein the outer housing comprises a thermally conductive material, wherein the outer housing comprises a thermally insulative material, and wherein the heat sink is thermally coupled to the heat pipe.

5. The case of claim 4, wherein the heat sink is coupled to the heat pipe by a thermal interface material extending from the heat pipe and through the outer housing.

6. The case of claim 4, further comprising thermally conductive wires extending within the outer housing from the heat pipe to the heat sink of the clip.

7. The case of claim 1, further comprising a fan configured to direct air between the multiple fins.

8. The case of claim 1, wherein the outer housing extends continuously about the elastic layer and the cavity between the first end and the second end.

9. A case for a battery device, the case comprising:
an outer housing forming an opening at a first end of the case and forming a cavity extending from the opening and within the outer housing toward a second end of the case, wherein the outer housing comprises a thermally insulative material;
a heat pipe extending within the outer housing, wherein the outer housing comprises a thermally conductive material; and
a clip formed by:
a portion of the heat pipe extending from the first end of the case and a portion of the outer housing; and
a heat sink extending toward the second end of the case and being thermally coupled to the heat pipe.

10. The case of claim 9, wherein the heat sink is coupled to the heat pipe by a thermal interface material extending from the heat pipe and through the outer housing.

11. The case of claim 9, further comprising an elastic layer within the outer housing and extending along inner walls of the outer housing.

12. The case of claim 9, wherein the heat sink forms multiple fins on an outer surface of the clip.

13. The case of claim 9, further comprising thermally conductive wires extending within the outer housing from the heat pipe to the heat sink of the clip.

14. The case of claim 9, wherein the outer housing extends continuously about the cavity between the first end and the second end.

15. A case for a portable electronic device and a battery device, the case comprising:
an outer housing forming an opening at a first end of the case and forming a cavity extending from the opening and within the outer housing toward a second end of the case, wherein the outer housing comprises a thermally insulative material;
a heat pipe extending within the outer housing, wherein the outer housing comprises a thermally conductive material;
a clip extending from the first end of the case, away from the outer housing, and toward the second end of the case; and
a fan configured to direct air across an outer surface of the clip.

16. The case of claim 15, further comprising a thermoelectric generator coupled to the heat pipe and configured to control operation of the fan based on a temperature gradient between the heat pipe and an ambient environment external to the case.

17. The case of claim 15, wherein the clip comprises a heat sink coupled to the heat pipe by a thermal interface material extending from the heat pipe and through the outer housing.

18. The case of claim 15, further comprising an elastic layer within the outer housing and extending along inner walls of the outer housing.

19. The case of claim 15, wherein the clip comprises a heat sink that forms multiple fins on the outer surface of the clip, wherein the fan is configured to direct the air between the multiple fins.

20. The case of claim 15, wherein the outer housing extends continuously about the cavity between the first end and the second end.
